(19) United States
(12) Patent Application Publication
(10) Pub. No.: US 2025/0104495 A1
(43) Pub. Date: Mar. 27, 2025

(54) CONTROLLING

(71) Applicant: ASSA ABLOY ABLOY AB, Stockholm (SE)

(72) Inventor: Kaj Niegmann, Huddinge (SE)

(21) Appl. No.: 18/832,214

(22) PCT Filed: Feb. 3, 2023
(86) PCT No.: PCT/EP2023/052659

§ 371 Date: Jul. 23, 2024

(30) Foreign Application Priority Data
Feb. 4, 2022 (SE) 2250109-2

(51) Int. Cl. G07C 9/00; G05B 15/02; H01H 36/00

(52) U.S. Cl. CPC G07C 9/00174; G05B 15/02; H01H 36/00; G07C 2009/00634

(57) ABSTRACT

A lock assembly for controlling its power state, the lock assembly being configured to control access to a restricted physical space secured by a door. The lock assembly comprises: an access control module , configured to selectively control the lock assembly to be in an unlocked state or a locked state, wherein the access control module comprises a processor and a magnetically controllable switch, configured to control an operative state of the processor based on an applied magnetic field; and a rotary member configured to rotate when a connected door handle rotates. The rotary member comprises a magnet for controlling the state of the magnetically controllable switch.

### TECHNICAL FIELD

The present disclosure relates to the field of a lock assembly and in particular to a lock assembly configured to control its power state, wherein the lock assembly controls access to a restricted physical space.

### BACKGROUND

Locks and keys are evolving from the traditional pure mechanical locks. These days, electronic locks are becoming increasingly common. For electronic locks, no mechanical key profile is needed for authentication of a user. The electronic locks can e.g. be opened using an electronic key stored on a special carrier (fob, card, etc.) or in a smartphone, or using biometry. Such electronic locks provide a number of benefits, including improved flexibility in management of access rights, audit trails, key management, etc.

One problem with electronic locks is that they need power. Electronic locks can be hard-wired, but this complicates installation significantly. Alternatively, electronic lock can be battery-powered which simplifies installation. However, batteries eventually run out, requiring someone to replace or recharge the battery.

### SUMMARY

One object is to provide an improved way to transition a lock assembly from a low-power state to an active state.

According to a first aspect, it is provided a lock assembly for controlling its power state. The lock assembly is configured to control access to a restricted physical space secured by a door. The lock assembly comprises: an access control module, configured to selectively control the lock assembly to be in an unlocked state or a locked state, wherein the access control module comprises a processor and a magnetically controllable switch, configured to control an operative state of the processor based on an applied magnetic field; and a rotary member configured to rotate when a connected door handle rotates. The rotary member comprises a magnet for controlling the state of the magnetically controllable switch such that the processor is unpowered when a connected handle is in a first state, in which a connected door handle is not being manipulated, and such that the processor is powered when a connected handle is in a second state, in which the rotational position of the door handle indicates intent to open.

The magnetically controllable switch may be configured to control power supply to the processor based on the applied magnetic field.

The magnetically controllable switch may be configured to transmit a wakeup signal to the processor based on the applied magnetic field.

The magnetically controllable switch may be in a blocking state when a connected handle is in the first state, and the magnetically controllable switch is in a conducting state when a connected handle is the second state.

The magnet may be provided to align with the magnetically controllable switch when a connected handle is its second state.

The access control module may be configured to evaluate access based on wireless communication with an electronic key.

The magnetically controllable switch may be a Reed switch.

The magnetically controllable switch may be a Hall detector.

The access control module may be configured to be provided on a restricted side of the door.

The lock assembly may further comprise the door handle.

The access control module may be configured to determine that tampering occurs by detecting that the magnetically controlled switch repetitively shifts between a conductive state and a blocking state.

The lock assembly may further comprise a main power supply and an auxiliary power supply. In this case, the magnetically controllable switch is configured to control power supply from the main power supply to the processor based on the applied magnetic field. The auxiliary power supply is chargeable by the main power supply, to power the processor when the main power supply is disconnected from the processor.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic top view of details of parts of the environment of FIG. 1 according to one embodiment;

FIG. 3 is a schematic side view of details of parts of the environment of FIG. 2 according to one embodiment; and

FIGS. 4A-B are schematic side views of the lock assembly of FIGS. 1-3, illustrating operation of the lock assembly 20 according to one embodiment.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide an effective and convenient solution to allow an access control module of a lock assembly implementing an electronic lock to be provided with extremely low standby power usage, yet with a robust and intuitive user interface to wake up the access control module. Specifically, the door handle on the outside is connected to a rotary member on the inside. The rotary member comprises a magnet. The access control module comprises a magnetically controllable switch, which connects or disconnects a processor of the access control module to a power supply depending on proximity to the magnet. When the user manipulates the door handle on the outside, i.e. rotates the door handle, this causes the rotary member to rotate, whose magnet affects the state of the magnetically controllable switch. This, in turn, controls an operative state of the processor. For instance, the switch can close the circuit between the power supply and the processor, thereby causing the access control module to wake up and enter an active state. Alternatively, the switch can close a circuit to provide a wakeup signal to the processor, to wake up from a dormant state. The access control module can then evaluate whether access is granted and unlock the door when access is granted. Hence, by simply rotating the handle on the outside, this causes the access control module to wake up, evaluate access and act accordingly. This is both an intuitive solution from a user perspective, and a power efficient solution for the access control module.

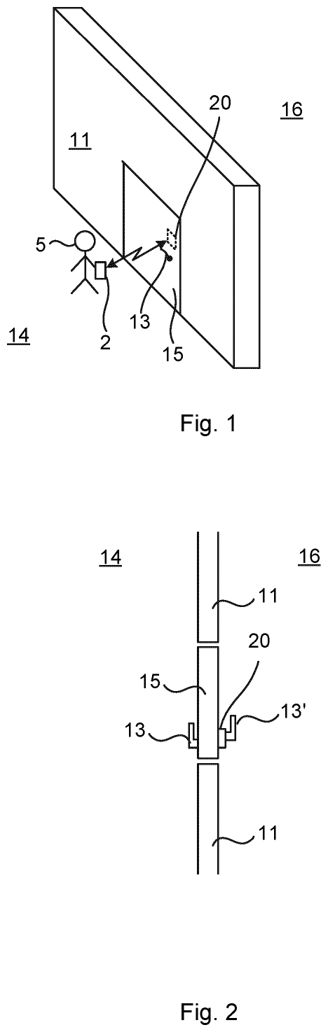

FIG. 1 is a schematic diagram illustrating an environment in which embodiments presented herein can be applied. Access to a physical space 16 is restricted by a door 15. The door 15 stands between the restricted physical space 16 and an accessible physical space 14. The restricted physical space 16 is inside the door 15 and the accessible physical space 14 is outside the door 15. The door 15 could also be implemented as a gate, hatch, window door, etc. In order to control access to the restricted physical space 16, a lock assembly 20 is provided. The lock assembly 20 implements an electronic lock and is mainly or completely provided on the inside of the door, in the restricted physical space 16, to reduce the risk of tampering by an attacker on the outside. The door 15 is provided in a surrounding fixed structure 11, such as a wall or fence. A door handle 13 is provided to allow a user 5 to open the door 15, when it is unlocked. The door handle 13 is rotatable and can be of any suitable type, e.g. a lever handle, a doorknob, etc.

The user 5 can carry a portable key device 2. The portable key device 2 is implemented using any suitable device which is portable by a user 5 and which can be evaluated by the lock assembly 20 to determine whether to grant access or not, by communicating over a communication channel with the portable key device 2. For instance, the portable key device 2 can be implemented as a smart phone, wearable device, key fob, smartcard, etc. The lock assembly 20 is able to communicate with the portable key device 2 over a communication channel which may be a short-range wireless interface.

The short-range wireless interface between the portable key device 2 and the lock assembly 20 is a radio frequency wireless interface and could e.g. employ Bluetooth Low Energy (BLE), Bluetooth, Radio Frequency Identification (RFID), Near-field Communication (NFC), Ultra-high Frequency (UHF), ZigBee, thread, any of the IEEE 802.11 standards, any of the IEEE 802.15 standards, etc. Using the communication channel, access control can be performed by the lock assembly 20.

Alternatively or additionally, the lock assembly 20 can evaluate access when by evaluating biometry of the user 5, e.g. using face recognition, fingerprint recognition, etc.

When the access control by the lock assembly 20 results in granted access, the lock assembly 20 is set in an unlocked state allowing the door 15 to be opened. In contrast, when the lock assembly 20 is in a locked state the door 15 cannot be opened. In this way, access to a closed space 16 is controlled by the lock assembly 20.

Optionally, the lock assembly 20 is connected to a communication network 8, which can be an internet protocol (IP) based network. The communication network 8 can e.g. comprise any one or more of a local wireless network, a cellular network, a wired local area network, a wide area network (such as the Internet), etc. A server 3 can also be connected to the communication network 8.

FIG. 2 is a schematic top view of details of parts of the environment of FIG. 1 according to one embodiment. It can here be seen how the lock assembly 20 is provided mounted on the inside of the door 15, i.e. in the restricted physical space 16. Furthermore, the door handle 13 is shown connected to an inside door handle 13′.

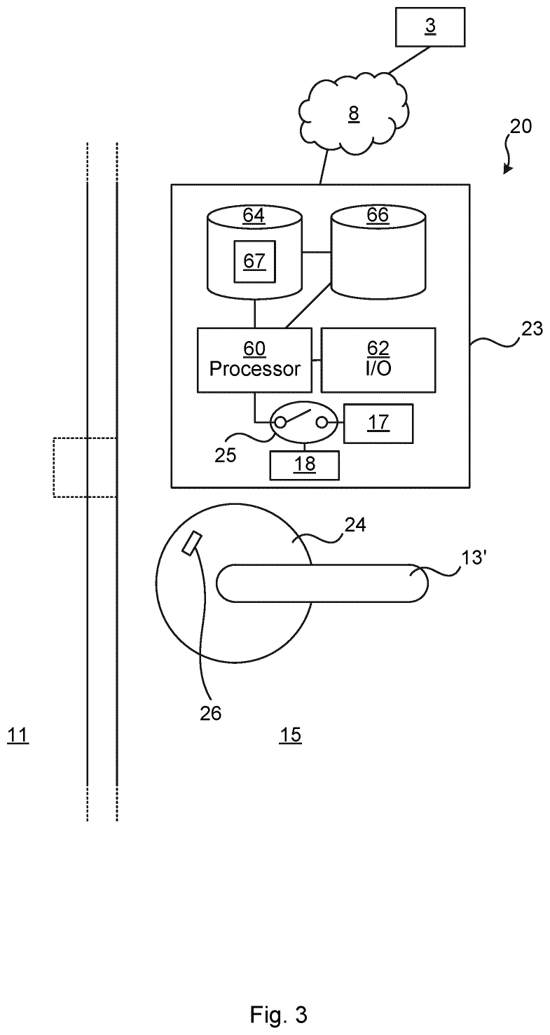

FIG. 3 is a schematic side view of details of parts of the environment of FIG. 2 according to one embodiment. The lock assembly 20 comprises an access control module 23 and a rotary member 24.

First, the access control module 23 will be described. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory. A data memory 66 is also provided for reading and/or storing data during execution of software instructions in the processor 60. The data memory 66 can be any combination of RAM and/or ROM.

The access control module 23 further comprises an I/O interface 62 for communicating with external and/or internal entities, such as the portable key device 2. Optionally, the I/O interface 62 contains communication capabilities to connect via a network to a server of an electronic access control system, for remote access control and/or remote configuration abilities. The network can be a wide area network, such as the Internet, to which the electronic lock 12 and/or the portable key device 2 can connect e.g. via Wi-Fi (e.g. any of the IEEE 802.11x standards) or a cellular network, e.g. LTE (Long Term Evolution), next generation mobile networks (fifth generation, 5G), UMTS (Universal Mobile Telecommunications System) utilising W-CDMA (Wideband Code Division Multiplex), etc. Optionally, the I/O interface 62 also includes a user interface.

There is a main power supply 17, such as a disposable or rechargeable battery, provided as part of the access control module 23 (as shown) or external to the access control device 23 (not shown). Optionally, there are complementary power sources to charge the battery to prolong battery power, e.g. based on solar power or energy harvesting to convert mechanical energy of turning the handle or opening the door to electrical energy, etc.

A magnetically controllable switch 25 is configured to control an operative state of the processor 60 based on an applied magnetic field. For instance, the magnetically controllable switch 25 can be provided between the main power supply 17 and the processor 60 to control when the processor 60 is connected to or disconnected from the main power supply 17. In such a case, the operative states of the processor 60 are powered or unpowered. Alternatively, the processor 60 is always connected to the main power supply 17, and the magnetically controllable switch 25 controls when a wakeup signal is to be provided to the processor 60. In such a case, the operative states of the processor are dormant (or asleep) and active. In one embodiment, there is an auxiliary power supply 18. The auxiliary power supply 18 can be a chargeable power supply, e.g. in the form of a capacitor, supercapacitor or battery. The auxiliary power supply 18 can be charged by the main power supply 17, e.g. when the main power supply 17 is connected (to the processor 60) under control of the magnetically controllable switch 25. The auxiliary power supply 18 can thereby power the processor 60 for some time even after the main power supply 17 has been disconnected by the magnetically controllable switch 25.

Other components of the access control module 23 are omitted in order not to obscure the concepts presented herein.

The rotary member 24 can be implemented as a rosette that is provided between the main section of the inside part of door handle 13′ and the door 15. The rotary member 24 is not fixed to the door 15, such that it is allowed to rotate. The rotary member 24 is connected to the door handle (at least the door handle 13 on the outside), such that when the outside door handle 13 is rotated, the rotary member also rotates.

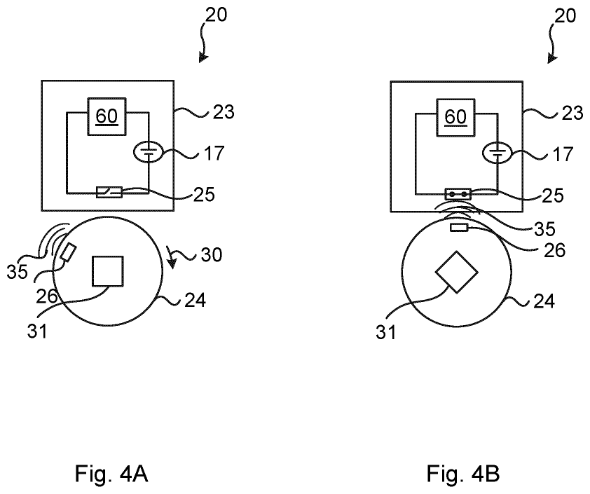

The rotatory member 24 comprises a magnet 26 for controlling the state of the magnetically controllable switch 25, as shown in more detail in FIGS. 4A and 4B and that is explained below. The magnet 26 is a permanent magnet and is fixedly mounted to the rotary member, so that the magnet moves when the rotary member 24 is rotated (caused by the outside handle 13).

FIGS. 4A-B are schematic side views of the lock assembly of FIGS. 1-3, illustrating operation of the lock assembly 20 according to one embodiment. As explained above, the lock assembly 20 controls access to the restricted physical space 16 secured by a door 15. In the interest of clarity, only parts of the access control module 23 that are relevant for describing its the power state operation are included in FIGS. 4A-B.

The access control module 23 is configured to selectively control the lock assembly 20 to be in an unlocked state or a locked state. As explained above, the magnetically controllable switch 25 is configured to control an operative state of the processor 60 based on an applied magnetic field. The magnetically controllable switch 25 can e.g. be provided between the power source 17 and the processor 60 or the magnetically controllable switch 25 can be provided to control when a wakeup signal is provided on a suitable input of the processor 60 (in which case the processor is constantly powered, but can be in a dormant state).

The rotary member 24 is configured to rotate when a connected door handle 13 rotates. This can be achieved by the door handle 13 on the outside being mounted on a spindle (e.g. a long metal piece having a square or rectangular cross-sectional shape), wherein the spindle is connected with an appropriate aperture 31 in the rotary member 24. In this way, when the handle 13 is rotated, this causes the spindle to rotate, which causes the rotary member 24 to rotate 30. Additionally, the spindle can be connected to mechanical components (not shown) of the lock assembly 20, to cause a bolt to retract from a matching striking plate.

As mentioned above, the rotary member 24 comprises a magnet 26. The magnet 26 is provided in a position on the rotary member 24 for controlling the state of the magnetically controllable switch 25. The rotary member 24 does not need to have any particular shape as long as the magnet 26 of the rotary member is controlled by the outside door handle 13 as described herein. Optionally, the rotary member 24 forms part of the inside handle 13′.

Specifically, as seen in FIG. 4A, a magnetic field 35 of the magnet 26 is such that it does not affect the magnetically controllable switch 25. In this case, the magnetically controllable switch 25 is in a blocking (also known as open) state. In one embodiment, this blocks power from the power source 17 from reaching the processor 60. The processor 60 is thus unpowered, whereby the lock assembly 20 (and the access control module 23) is in a low-power (standby) state. In one embodiment, the blocking state of the switch 25 prevents a wakeup signal from being provided to the processor 60. The blocking state of the state of the switch 25 occurs when a connected handle 13 is in a first state, in which a connected door handle 13 is not being manipulated, e.g. when no user is present at the outside of the door. In this standby state of the lock assembly, no power or very small amounts of power is consumed by the processor 60.

Looking now to FIG. 4B, the magnetic field 35 of the magnet 26 is close enough to the magnetically controllable switch 25 to set the magnetically controllable switch 25 in a conducting (also known as closed) state. In one embodiment, this causes the processor 60 is here powered. In one embodiment, this causes a wakeup signal to be provided to the processor. Regardless, in the scenario of FIG. 4B, the lock assembly 20 (and the access control module 23) is controlled to be in an active state. This occurs when the connected handle 13 is in a second state, in which the rotational position of the door handle 13 indicates intent to open, i.e. when the user 5 is present on the outside of the door 15, and the user 5 has rotated the door handle 13 in order to open the door 15. The magnet 26 is thus provided to align with the magnetically controllable switch 25 when a connected handle 13 is manipulated to rotate from its first state to its second state.

Once the processor is powered, the access control module evaluates access for the user 5 based on wireless communication with an electronic key 2, as known in the art per se. When access is granted, the lock assembly 20 unlocks and the user can enter the restricted space. When access is denied, the lock assembly 20 stays unlocked. Additionally, the failed access attempt can be logged and the owner of the lock can be informed of the failed access attempt. The lock assembly 20 can send an alarm signal to a server 3 or other entity, e.g. when the number of failed access attempts exceed a specific threshold. Alternatively, the lock assembly 20 can send an alarm signal whenever there is a failed access attempt, e.g. for high security applications.

The magnetically controllable switch 25 can be a Reed switch, which is a passive component. In this case, no power is consumed when the Reed switch is open, when the lock assembly is in the low-power state.

Alternatively, the magnetically controllable switch 25 is a Hall detector. While the Hall detector does consume a small amount of power in an open state, the Hall detector can detect the strength of the magnetic field 35, which can be used to determine a rotational position of the rotary member 24. The rotational position can be used for alternative user input actions. For instance, if the outside handle 13 is rotated in an opposite direction from indicating a desire to open the door 15, this can be interpreted as an alternative user input.

While the door handle 13 can be provided separately, in one embodiment the lock assembly 20 comprises the door handle 13.

When the lock assembly is caused to enter the active state and authorisation fails, this can be recorded. In this way, the owner, or other authorised users, can be informed of the unauthorized attempted access. Such information can be provided in any suitable form, e.g. communicated with a gateway device to send a message to the authorised user(s) to an application on a smartphone, as a text message, and/or as an e-mail message.

Optionally, the magnetically controllable switch 25 is configured to control power supply from the main power supply 17 to the processor 60 based on the applied magnetic field, and the auxiliary power supply 18 is chargeable by the main power supply 17. In this way, the processor 60 is powered by the auxiliary power supply 18 when the main power supply 17 is disconnected from the processor 60. The auxiliary power supply 18 only needs to have sufficient charge to power the processor 60 to perform its actions.

Optionally, the access control module 23 is configured to determine that tampering occurs by detecting that the magnetically controlled switch repetitively shifts between a conductive state and a blocking state. For instance, an attacker may attempt to repetitively turn the handle to attempt to mechanically break in through the door 15. This handle manipulation will repetitively shift the state of the magnetically controllable switch 25 between the blocking state and the conductive state. By detecting the repetitive state changes of the magnetically controllable switch 25, this type of attack can be detected. When combined with the auxiliary power supply 18, this detection can occur for each time that the processor 60 is powered (i.e. turned on) and for as long as the auxiliary power supply 18 powers the processor. Optionally, the lock assembly 20 comprises a running clock that can be used to measure time instances (e.g. relative to when the main power supply 17 was connected) for state changes of the magnetically controllable switch 25. In this way, tampering can e.g. be detected if there are more than n state changes in t seconds.

A use case scenario will now be described to further illustrate how embodiments presented herein can be applied. A user 5 carrying a portable key device 2 wants to enter into a restricted physical space 16 and approaches the door 15. The user manipulated the door handle 5, turning the handle 13 as is customary when wanting to open the door 15. The turning of the handle 13 causes the rotary member 24 on the inside to rotate, whereby the magnet 26 of the rotary member aligns with the magnetically controllable switch 25. The magnetic field 35 from the magnet 26 causes the magnetically controllable switch 25 to close, whereby power from the main power supply 17 powers the processor 60 or a wakeup signal is provided to the processor 60. This causes the processor and the access control module 23 (and the lock assembly 20) to wake up and enter the active state. The access control module 23 communicates with the portable key device 2 and evaluates access. When access is granted, the lock assembly is set in an unlocked state. The user 5, who turns door handle to open the door 15, can thus continue the normal, natural action of opening the door (that is now unlocked) and enter the restricted physical space 16. When the time to evaluate access is sufficiently short, access is evaluated quickly enough for the user 5 to both trigger the wake-up of the lock assembly 20 and the access control module 23 to evaluate access. The whole process is transparent for the user 5.

Embodiments presented herein provide a way to improve how a lock assembly is woken up from a standby state. This is performed in a manner which is intuitive for the user and that is power efficient. Moreover, the solution is easy to retrofit for an existing pure mechanical lock, where only the rotary member and the access control module 23 are easily installed on the inside of the door. There is no need for any modifications of mechanical components of a previously installed mechanical lock.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-12. (canceled)

13. A lock assembly for controlling its power state, the lock assembly being configured to control access to a restricted physical space secured by a door, the lock assembly comprising:
an access control module configured to selectively control the lock assembly to be in an unlocked state or a locked state, wherein the access control module comprises a processor and a magnetically controllable switch configured to control an operative state of the processor based on an applied magnetic field; and
a rotary member configured to rotate when a connected door handle rotates;
wherein the rotary member comprises a magnet for controlling a state of the magnetically controllable switch such that the processor is unpowered when the connected door handle is in a first state, in which the connected door handle is not being manipulated, and such that the processor is powered when the connected door handle is in a second state, in which a rotational position of the connected door handle indicates intent to open.

14. The lock assembly according to claim 13, wherein the magnetically controllable switch is configured to control power supply to the processor based on the applied magnetic field.

15. The lock assembly according to claim 13, wherein the magnetically controllable switch is configured to transmit a wakeup signal to the processor based on the applied magnetic field.

16. The lock assembly according to claim 13, wherein the magnetically controllable switch is in a blocking state when the connected door handle is in the first state, and the magnetically controllable switch is in a conducting state when the connected door handle is in the second state.

17. The lock assembly according to claim 13, wherein the magnet is provided to align with the magnetically controllable switch when the connected door handle is in its second state.

18. The lock assembly according to claim 13, wherein the access control module is configured to evaluate access based on wireless communication with an electronic key.

19. The lock assembly according to claim 13, wherein the magnetically controllable switch is a Reed switch.

20. The lock assembly according to claim 13, wherein the magnetically controllable switch is a Hall detector.

21. The lock assembly according to claim 13, wherein the access control module is configured to be provided on a restricted side of the door.

22. The lock assembly according to claim 13, further comprising the connected door handle.

23. The lock assembly according to claim 13, wherein the access control module is configured to determine that tampering occurs by detecting that the magnetically controlled switch repetitively shifts between a conductive state and a blocking state.

24. The lock assembly according to claim 13, further comprising a main power supply and an auxiliary power supply, wherein the magnetically controllable switch is configured to control power supply from the main power supply to the processor based on the applied magnetic field, and the auxiliary power supply is chargeable by the main power supply to power the processor when the main power supply is disconnected from the processor.
